(19) United States
(12) Patent Application Publication
(10) Pub. No.: US 2026/0356354 A1
(43) Pub. Date: Nov. 12, 2026

(54) PARKING ASSISTANCE DEVICE

(71) Applicant: TOYOTA JIDOSHA KABUSHIKI KAISHA, Toyota-shi (JP)

(72) Inventors: Tatsuya SUGANO, Seto-shi (JP); Takahiro Yamamoto, Toyota-shi (JP); Chenyang Wang, Nagoya-shi (JP)

(73) Assignee: TOYOTA JIDOSHA KABUSHIKI KAISHA, Toyota-shi (JP)

(21) Appl. No.: 19/638,458

(22) Filed: Apr. 3, 2026

(30) Foreign Application Priority Data
May 12, 2025 (JP) 2025-079509

(51) Int. Cl. B60W 30/06

(52) U.S. Cl. CPC B60W 30/06; B60W 2554/4029

(57) ABSTRACT

A parking assistance device executes parking assistance control of parking a vehicle in a parking space in response to an operation of a user on an operation terminal located outside the vehicle. In a case where a predetermined interruption condition is satisfied while the user is located outside a first range set around the vehicle during the execution of the parking assistance control, the parking assistance device interrupts the parking assistance control and decelerates the vehicle, and in a case where a predetermined resumption condition is satisfied while the user is located within the first range during the interruption of the parking assistance control, the parking assistance device resumes the parking assistance control. The interruption condition is set to be more likely to be satisfied than the resumption condition.

### CROSS-REFERENCE TO RELATED APPLICATION

This application claims priority to Japanese Patent Application No. 2025-079509 filed on May 12, 2025. The disclosure of the above-identified application, including the specification, drawings, and claims, is incorporated by reference herein in its entirety.

### BACKGROUND

### 1. Technical Field

The present disclosure relates to a parking assistance device that executes parking assistance control for parking a vehicle in a parking space in response to an operation by a user on an operation terminal located outside the vehicle.

### 2. Description of Related Art

In the related art, a parking assistance device that executes parking assistance control is known. For example, the parking assistance device (hereinafter, referred to as the “conventional device”) described in Japanese Unexamined Patent Application Publication No. 2018-086920 (JP 2018-086920 A) moves a vehicle toward a parking space in response to a remote operation by a user in a case where an operation terminal is located in a “permission range that is predetermined with respect to the vehicle” (that is, in a case where the user is located in the permission range). On the other hand, in the conventional device, in a case where the user is located outside the permission range, the parking assistance control is interrupted, and the vehicle is decelerated to a stop.

### SUMMARY

In a case where the user is located near a boundary line of the permission range, the parking assistance control may be repeatedly interrupted and resumed. On the other hand, in a case where the user is located outside the deceleration start range set outside the permission range, the vehicle is configured to reliably decelerate.

The present disclosure has been made to solve the problem. That is, one object of the present disclosure is to provide a parking assistance device that increases a probability that the vehicle decelerates in a case where the user is located outside the deceleration start range while reducing a probability that the parking assistance control is repeatedly interrupted and resumed.

A parking assistance device according to the present disclosure executes parking assistance control for parking a vehicle in a parking space in response to an operation by a user on an operation terminal located outside the vehicle (step 430, step 435).

A parking assistance device according to the present disclosure executes parking assistance control for parking a vehicle in a parking space in response to an operation by a user on an operation terminal located outside the vehicle (step 430, step 435). The parking assistance device is configured to interrupt the parking assistance control and decelerate the vehicle (step 445) in a case where an interruption condition that is predetermined is satisfied while the user is located outside a first range set around the vehicle during execution of the parking assistance control (step 335: "Yes", step 340, step 465: "Yes"), and resume the parking assistance control (step 435) in a case where a resumption condition that is predetermined is satisfied while the user is located within the first range during interruption of the parking assistance control (step 370: "Yes", step 375, step 465: "No"), and the interruption condition is set to be more likely to be satisfied than the resumption condition.

Since the interruption condition is more likely to be satisfied than the resumption condition, it is possible to increase a probability that the vehicle decelerates in a case where the user is located outside the “deceleration start range (second range) set outside the first range”. Further, since the resumption condition is less likely to be satisfied than the interruption condition, even in a case where the user is located near a boundary line of the first range, the parking assistance control is less likely to be resumed after the parking assistance control is temporarily interrupted. As a result, it is possible to reduce a probability that the parking assistance control is repeatedly interrupted and resumed.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic system configuration diagram of a parking assistance device according to an embodiment of the present disclosure;

FIG. 2 is an explanatory diagram of a first range and a second range set around the vehicle shown in FIG. 1;

FIG. 3 is a flowchart of an interruption and resumption determination routine executed by a CPU of an ECU shown in FIG. 1;

FIG. 4 is a flowchart of a parking assistance control routine executed by the CPU of the ECU shown in FIG. 1; and

FIG. 5 is a flowchart of a threshold value time setting routine executed by the CPU of the ECU of the parking assistance device according to a first modification of the embodiment of the present disclosure.

### DETAILED DESCRIPTION OF EMBODIMENTS

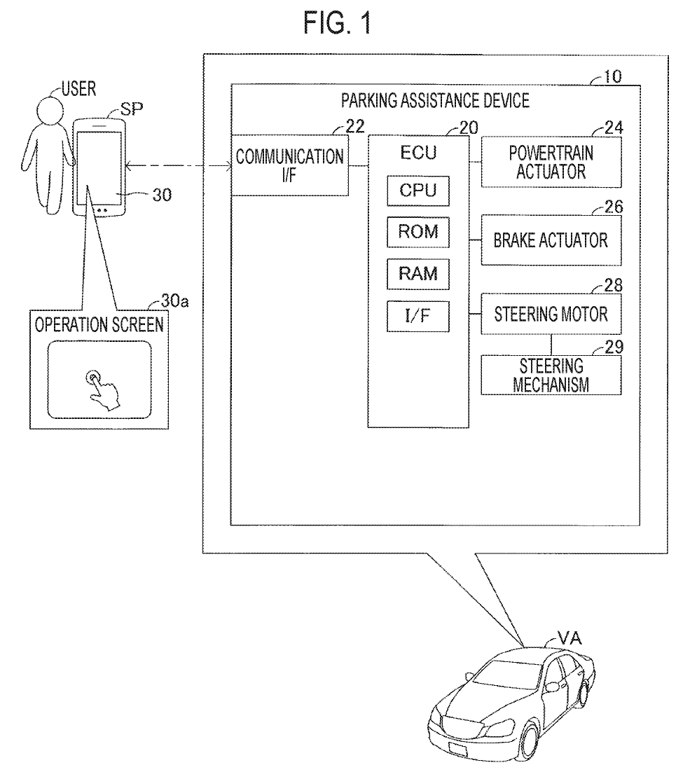

As shown in FIG. 1, a parking assistance device 10 (hereinafter, referred to as “the device 10”) according to the present embodiment is applied to a vehicle VA. The device 10 establishes communication with a smartphone SP operated by the user and transmits and receives data.

The device 10 includes the components shown in FIG. 1. In the present specification, the “ECU 20” is an electronic control device including a microcomputer as a main part. The ECU 20 is also referred to as a control unit, a controller, and a computer. The microcomputer includes a CPU (processor), a ROM, a RAM, an interface (I/F), and the like. The functions realized by the ECU 20 may be realized by a plurality of ECUs.

A communication interface (I/F) 22 is an interface for transmitting and receiving data to and from the smartphone SP. A powertrain actuator 24 changes a drive force generated by a drive device (for example, an internal combustion engine and/or an electric motor) of the vehicle VA. A brake actuator 26 controls a braking force applied to the vehicle VA. A steering motor 28 is incorporated in a steering mechanism 29. The steering mechanism 29 is a mechanism for steering the steered wheels of the vehicle VA in response to an operation of a steering wheel. Further, the steering motor 28 generates, in the steering mechanism 29, an automatic steering torque for changing a steering angle of the steered wheels in response to an instruction from the ECU 20.

The smartphone SP is installed with a parking assistance application and an electronic key application. In a case where the parking assistance application is activated, the smartphone SP displays a “parking space designation screen for the user to designate the parking space” on a display device 30 that is a touch panel type display. In a case where the user performs a touch operation on the parking space on the parking space designation screen, the smartphone SP transmits a start signal including designation information for specifying the parking space designated by the user to the device 10. An operation screen 30a shown in FIG. 1 is displayed on the display device 30. The user places a finger on an operation input region of the operation screen 30a and continues to move the finger. This operation is referred to as a “remote operation”. While the user is performing the remote operation, the smartphone SP transmits a remote operation instruction to the device 10. The device on which the user performs the remote operation may be referred to as an “operation terminal”.

The electronic key application performs communication with the device 10 each time a predetermined time elapses. The device 10 specifies the position of the user with respect to the device 10 (that is, the vehicle VA) of the smartphone SP based on the communication with the electronic key application.

### Parking Assistance Control

In a case where the vehicle VA is parked by the parking assistance control, the user goes out of the vehicle VA and operates the smartphone SP. In a case where the start signal is received from the smartphone SP, the ECU 20 starts the parking assistance control. Specifically, the ECU 20 specifies the parking space based on the designation information included in the start signal and acquires a route to the parking space. In a case where the remote operation instruction is received, the ECU 20 controls the powertrain actuator 24, the brake actuator 26, and the steering motor 28 such that the vehicle VA travels along the route at a predetermined parking speed or less. Further, in a case where the parking space is close, the ECU 20 controls the powertrain actuator 24, the brake actuator 26, and the steering motor 28 such that the vehicle VA stops at the parking space.

### Summary of Operation

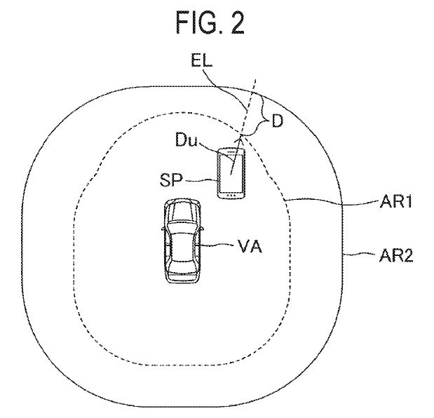

As shown in FIG. 2, a first range AR1 is set with respect to the vehicle VA. A second range AR2 is set outside the first range AR1. While the parking assistance control is being executed, the user needs to monitor the vehicle VA. Therefore, while the parking assistance control is being executed, the user is required to be located in the first range AR1. Further, in a case where the user is located outside the second range AR2, the user is likely not to monitor the vehicle VA. Therefore, in a case where the user is located outside the second range AR2, it is required that the vehicle VA reliably decelerates.

While the parking assistance control is being executed, the ECU 20 specifies the position of the smartphone SP with respect to the vehicle VA as the position of the user with respect to the vehicle VA by performing communication with the electronic key application of the smartphone SP.

In a case where the predetermined interruption condition is satisfied while the user is located outside the first range AR1, the ECU 20 interrupts the parking assistance control (that is, interrupts the movement of the vehicle VA by the parking assistance control) and decelerates the vehicle VA at a predetermined deceleration. Specifically, in a case where the time Tout outside the range in which the user is located outside the first range AR1 is equal to or longer than an interruption threshold value time Tstop, the ECU 20 determines that the interruption condition is satisfied.

In a case where the predetermined resumption condition is satisfied while the user is located within the first range AR1 during the interruption of the parking assistance control, the ECU 20 resumes the parking assistance control to move the vehicle VA toward the parking space again. Specifically, in a case where the time Tin within the range in which the user is located within the first range AR1 is equal to or longer than a resumption threshold value time Tstart, the ECU 20 determines that the resumption condition is satisfied.

In the present embodiment, the interruption condition is set to be more likely to be satisfied than the resumption condition. Specifically, the interruption threshold value time Tstop is set to be shorter than the resumption threshold value time Tstart.

As a result, in a case where the user is located outside the first range AR1, the interruption condition is satisfied immediately, so that a probability that the vehicle VA decelerates in a case where the user is located outside the second range AR2 can be increased. Since the resumption condition is less likely to be satisfied in a case where the user is located within the first range AR1, the parking assistance control is less likely to be resumed after the parking assistance control is temporarily interrupted even in a case where the user is located near a boundary line of the first range AR1. Therefore, a probability that the parking assistance control is repeatedly interrupted and resumed can be reduced.

### Specific Operation

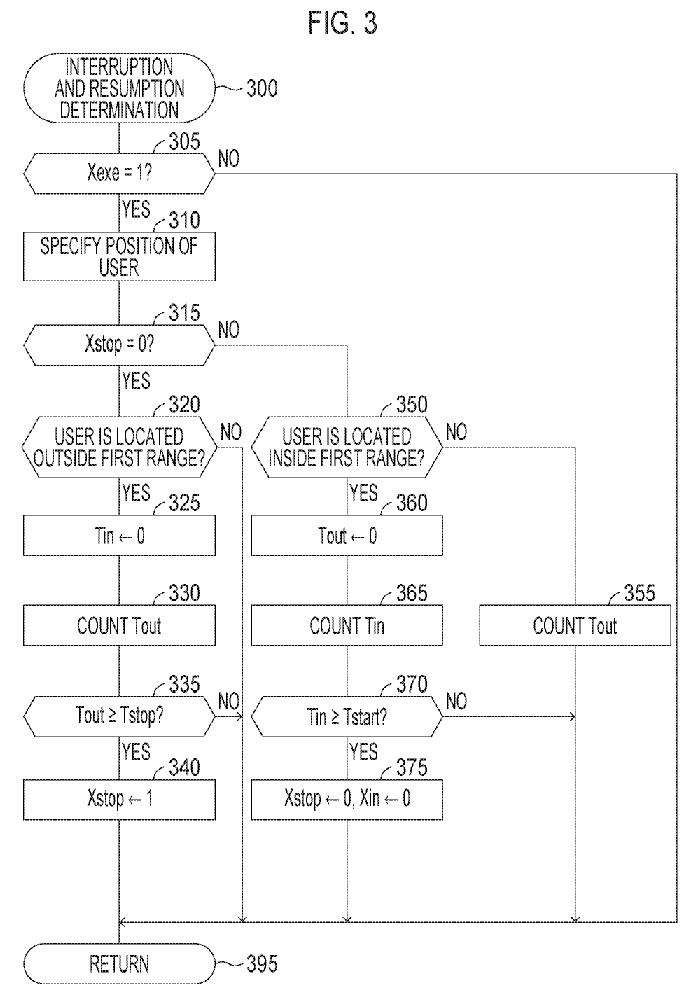

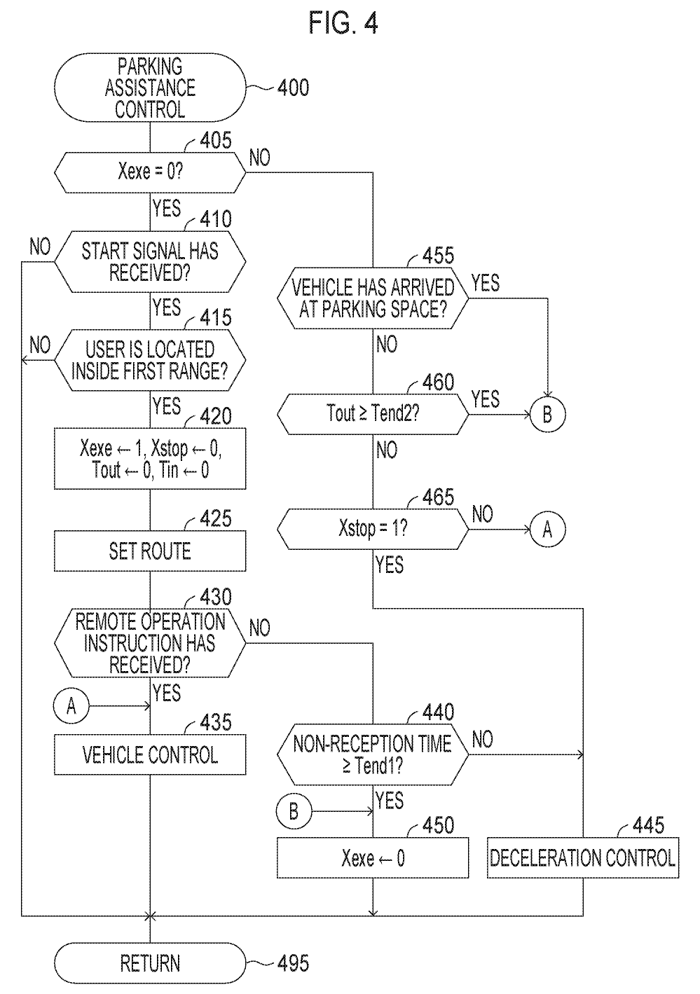

The CPU of the ECU 20 executes the routines shown in the flowcharts of FIGS. 3 and 4 each time a predetermined time elapses.

### Interruption and Resumption Determination Routine

In a case where an appropriate time arrives, the CPU starts processing from step 300 of FIG. 3, and the processing proceeds to step 305. In step 305, the CPU determines whether the execution flag Xexe is “1”. The execution flag Xexe is set to “1” in a case where the parking assistance control is executed, and is set to “0” in a case where the parking assistance control is not executed. The execution flag Xexe is set to “0” in an initialization routine. The initialization routine is executed by the CPU in a case where an ignition key switch (not shown) of the vehicle VA is changed from an off position to an on position.

In a case where the execution flag Xexe is “0”, the CPU determines “No” in step 305, and the processing proceeds to step 395. In step 395, the CPU temporarily ends the present routine.

In a case where the execution flag Xexe is “1”, the CPU determines “Yes” in step 305, and executes step 310 and step 315.

Step 310: The CPU specifies the position of the user with respect to the vehicle VA.

Step 315: The CPU determines whether the interruption flag Xstop is “0”.

The interruption flag Xstop is set to “1” in a case where the parking assistance control is interrupted, and is set to “0” in a case where the parking assistance control is not interrupted. The interruption flag Xstop is set to “0” in the initialization routine.

In a case where the interruption flag Xstop is “0”, the CPU determines “Yes” in step 315, and the processing proceeds to step 320. In step 320, the CPU determines whether the user is located outside the first range AR1.

In a case where the user is located within the first range AR1, the CPU determines “No” in step 320, and the processing proceeds to step 395. In a case where the user is located outside the first range AR1, the CPU determines “Yes” in step 320, and executes step 325 to step 335.

Step 325: The CPU sets the time Tin within the range to “0”.

Step 330: The CPU counts the time Tout outside the range.

Specifically, the CPU adds an “execution interval of the interruption and resumption determination routine” to the time Tout outside the range.

Step 335: The CPU determines whether the time Tout outside the range is equal to or longer than the interruption threshold value time Tstop.

In a case where the time Tout outside the range is shorter than the interruption threshold value time Tstop, the CPU determines “No” in step 335, and the processing proceeds to step 395.

In a case where the time Tout outside the range is equal to or longer than the interruption threshold value time Tstop, the CPU determines that the interruption condition is satisfied. In this case, the CPU determines “Yes” in step 335, and the processing proceeds to step 340. In step 340, the CPU sets the interruption flag Xstop to “1”. Thereafter, the processing proceeds to step 395.

In a case where the interruption flag Xstop is “1” in a case where the processing proceeds to step 315, the CPU determines “No” in step 315, and the processing proceeds to step 350. In step 350, the CPU determines whether the user is located within the first range AR1.

In a case where the user is located outside the first range AR1, the CPU determines “No” in step 350, and the processing proceeds to step 355. In step 355, the CPU counts the time Tout outside the range. Thereafter, the processing proceeds to step 395.

On the other hand, in a case where the user is located within the first range AR1, the CPU determines “Yes” in step 350, and the processing proceeds to step 360 to step 370.

Step 360: The CPU sets the time Tout outside the range to “0”.

Step 365: The CPU counts the time Tin within the range.

Specifically, the CPU adds an “execution interval of the interruption and resumption determination routine” to the time Tin within the range.

Step 370: The CPU determines whether the time Tin within the range is equal to or longer than the resumption threshold value time Tstart.

In a case where the time Tin within the range is shorter than the resumption threshold value time Tstart, the CPU determines “No” in step 370, and the processing proceeds to step 395.

In a case where the time Tin within the range is equal to or longer than the resumption threshold value time Tstart, the CPU determines that the resumption condition is satisfied. In this case, the CPU determines “Yes” in step 370, and the processing proceeds to step 375. In step 375, the CPU sets the interruption flag Xstop to “0” and sets the time Tin within the range to “0”. Thereafter, the processing proceeds to step 395.

### Parking Assistance Control Routine

In a case where an appropriate time arrives, the CPU starts processing from step 400 of FIG. 4, and the processing proceeds to step 405. In step 405, the CPU determines whether the execution flag Xexe is “0”.

In a case where the execution flag Xexe is “0”, the CPU determines “Yes” in step 405, and the processing proceeds to step 410. In step 410, the CPU determines whether the device 10 has received the start signal from the smartphone SP.

In a case where the device 10 has not received the start signal, the CPU determines “No” in step 410, and the processing proceeds to step 495. In step 495, the CPU temporarily ends the present routine.

In a case where the device 10 has received the start signal, the CPU determines “Yes” in step 410, and the processing proceeds to step 415. In step 415, the CPU determines whether the user is located within the first range AR1.

In a case where the user is located outside the first range AR1, the CPU determines “No” in step 415, and the processing proceeds to step 495.

In a case where the user is located within the first range AR1, the CPU determines “Yes” in step 415, and executes step 420 to step 430.

Step 420: The CPU sets the execution flag Xexe to “1” and sets the interruption flag Xstop to “0”. Further, the CPU sets the time Tout outside the range and the time Tin within the range to “0”.

Step 425: The CPU sets the route to the parking space.

Step 430: The CPU determines whether the device 10 has received the remote operation instruction from the smartphone SP.

In a case where the device 10 has received the remote operation instruction, the CPU determines “Yes” in step 430, and the processing proceeds to step 435. In step 435, the CPU controls the powertrain actuator 24, the brake actuator 26, and the steering motor 28 such that the vehicle VA travels along the route at a predetermined parking speed or less. Thereafter, the processing proceeds to step 495, and the CPU temporarily ends the present routine.

On the other hand, in a case where the device 10 has not received the remote operation instruction, the CPU determines “No” in step 430, and the processing proceeds to step 440. In step 440, the CPU determines whether a non-reception time representing a time during which the device 10 has not received the remote operation instruction is equal to or longer than a predetermined first end threshold value time Tend1.

In a case where the non-reception time is shorter than the first end threshold value time Tend1, the CPU determines “No” in step 440, and the processing proceeds to step 445. In step 445, the powertrain actuator 24 and the brake actuator 26 are controlled such that the vehicle VA decelerates at a predetermined deceleration. Thereafter, the processing proceeds to step 495.

In a case where the execution flag Xexe is “1” in a case where the processing proceeds to step 405, the CPU determines “No” in step 405, and the processing proceeds to step 455. In step 455, the CPU determines whether the vehicle VA has arrived at the parking space.

In a case where the vehicle VA has not arrived at the parking space, the CPU determines “No” in step 455, and the processing proceeds to step 460. In step 460, the CPU determines whether the time Tout outside the range is equal to or longer than a second end threshold value time Tend2. The second end threshold value time Tend2 is set to a value larger than the interruption threshold value time Tstop.

In a case where the time Tout outside the range is shorter than the second end threshold value time Tend2, the CPU determines “No” in step 460, and the processing proceeds to step 465. In step 465, the CPU determines whether the interruption flag Xstop is “1”.

In a case where the interruption flag Xstop is “0”, the CPU determines “No” in step 465, and the processing proceeds to step 435. As a result, the vehicle VA moves toward the parking space along the route.

In a case where the interruption flag Xstop is “1”, the CPU determines “Yes” in step 465, and the processing proceeds to step 445. As a result, the movement of the vehicle VA by the parking assistance control is interrupted, and the vehicle VA decelerates.

As described above, the interruption condition is set to be more likely to be satisfied than the resumption condition. As a result, a probability that the vehicle VA decelerates in a case where the user is located outside the second range AR2 can be increased, and a probability that the parking assistance control is repeatedly interrupted and resumed can also be reduced.

The present disclosure is not limited to the above-described embodiment, and various modifications can be adopted within the scope of the present disclosure.

### First Modification

In the example shown in FIG. 2, the first range AR1 of the region in front of the vehicle VA is longer in distance from the vehicle VA than other regions. On the other hand, the distance between the second range AR2 and the vehicle VA is substantially the same in any region. That is, the shape of the first range AR1 and the shape of the second range AR2 are not necessarily similar, and a region in which the interval between the first range AR1 and the second range AR2 is narrow and a region in which the interval is wide may occur.

Further, even in a case where the interval between the first range AR1 and the second range AR2 is uniform, the distance D (hereinafter, referred to as an “inter-range distance D”) between the first range AR1 and the second range AR2 in which the vehicle VA moves varies depending on the movement direction of the vehicle VA and the movement direction of the user.

In the present modification, in a case where the inter-range distance D is shorter than a threshold value distance Dth, the ECU 20 sets the interruption condition to be more likely to be satisfied than the resumption condition, as in the above-described embodiment. This is because, in a situation where the inter-range distance D is relatively short, in a case where the user is located outside the first range AR1, the vehicle VA cannot be decelerated in a case where the user is located outside the second range AR2 unless the parking assistance control is interrupted at an earliest timing to start decelerating the vehicle VA.

On the other hand, in a case where the inter-range distance D is equal to or longer than the threshold value distance Dth, the ECU 20 sets the interruption condition to be less likely to be satisfied than the resumption condition. This is because, in a situation where the inter-range distance D is relatively long, even in a case where the parking assistance control is interrupted at a late timing to start decelerating the vehicle VA in a case where the user is located outside the first range AR1, the vehicle VA is likely to be decelerated in a case where the user is located outside the second range AR2. Therefore, the interruption condition is set to be less likely to be satisfied than the resumption condition in order to shorten the time until the vehicle VA reaches the parking space. As a result, a probability that the parking assistance control is repeatedly interrupted and resumed can also be reduced by setting the interruption condition to be less likely to be satisfied than the resumption condition.

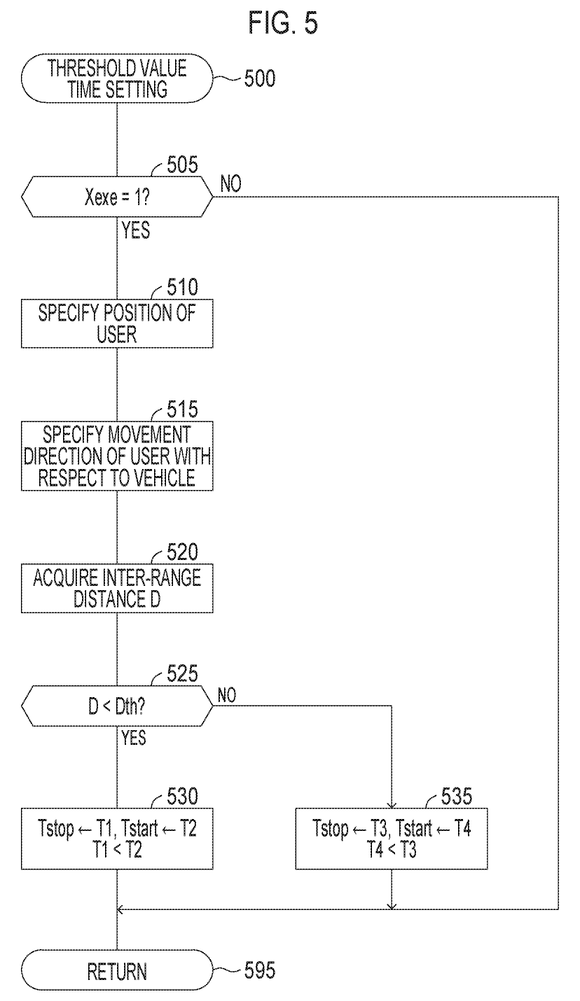

The CPU of the ECU 20 of the present modification also executes the routine shown in the flowchart of FIG. 5 each time a predetermined time elapses, in addition to the routines shown in the flowcharts of FIGS. 3 and 4.

### Threshold Value Time Setting Routine

In a case where an appropriate time arrives, the CPU starts processing from step 500 of FIG. 5, and the processing proceeds to step 505. In step 505, the CPU determines whether the execution flag Xexe is “1”.

In a case where the execution flag Xexe is “0”, the CPU determines “No” in step 505, and the processing proceeds to step 595. In step 595, the CPU temporarily ends the present routine.

In a case where the execution flag Xexe is “1”, the CPU determines “Yes” in step 505, and executes step 510 to step 525.

Step 510: The CPU specifies the position of the user with respect to the vehicle VA.

Step 515: The CPU specifies the movement direction Du (see FIG. 2) of the user with respect to the vehicle VA based on the movement direction of the user and the movement direction of the vehicle VA.

The CPU specifies the movement direction of the vehicle VA based on the steering angle of the steered wheels of the vehicle VA. Further, the CPU specifies the movement direction Du of the user with respect to the vehicle VA based on the history of the movement direction of the vehicle VA and the history of the position of the user with respect to the vehicle VA.

Step 520: The CPU acquires a distance on an “extension line EL (see FIG. 2) of the movement direction Du of the user with respect to the vehicle VA with the position of the user with respect to the vehicle VA as a starting point” between the first range AR1 and the second range AR2 as the inter-range distance D.

Step 525: The CPU determines whether the inter-range distance D is shorter than the threshold value distance Dth.

In a case where the inter-range distance D is shorter than the threshold value distance Dth, the CPU determines “Yes” in step 525, and the processing proceeds to step 530. In step 530, the CPU sets the interruption threshold value time Tstop to time T1 and sets the resumption threshold value time Tstart to time T2. Time T1 is shorter than time T2. Therefore, the interruption condition is more likely to be satisfied than the resumption condition. Thereafter, the processing proceeds to step 595.

On the other hand, in a case where the inter-range distance D is equal to or longer than the threshold value distance Dth, the CPU determines “No” in step 525, and the processing proceeds to step 535. In step 535, the CPU sets the interruption threshold value time Tstop to time T3 and sets the resumption threshold value time Tstart to time T4. Time T4 is shorter than time T3. Therefore, the resumption condition is more likely to be satisfied than the interruption condition. Thereafter, the processing proceeds to step 595. Time T4 may be the same value as time T1, and time T3 may be the same value as time T2.

### Second Modification

A range-out traveling distance Dout representing a traveling distance during which the vehicle VA travels while the user is located outside the first range AR1 from the time the user is located outside the first range AR1 may be used instead of the time Tout outside the range. Specifically, in a case where the traveling distance Dout outside the range is equal to or longer than a predetermined interruption threshold value distance, it may be determined that the interruption condition is satisfied.

Similarly, a range-in traveling distance Din representing a traveling distance during which the vehicle VA travels while the user is located within the first range AR1 from the time the user is located within the first range AR1 may be used instead of the time Tin within the range. Specifically, in a case where the range-in traveling distance Din is equal to or longer than a predetermined resumption threshold value distance, it may be determined that the resumption condition is satisfied.

### Third Modification

The ECU 20 may specify the position of the user with respect to the vehicle VA based on image data captured by a camera mounted on the vehicle VA. Further, the ECU 20 may specify the position of the user with respect to the vehicle VA by communicating with an electronic key device different from the smartphone carried by the user.

The device 10 can be applied to a vehicle such as an engine vehicle, a hybrid electric vehicle, a plug-in hybrid vehicle, a fuel cell electric vehicle, and a battery electric vehicle. The parking assistance control is a type of autonomous driving to assist the driving of the user.

What is claimed is:

1. A parking assistance device that executes parking assistance control for parking a vehicle in a parking space in response to an operation by a user on an operation terminal located outside the vehicle, wherein:
the parking assistance device is configured to
interrupt the parking assistance control and decelerate the vehicle in a case where an interruption condition that is predetermined is satisfied while the user is located outside a first range set around the vehicle during execution of the parking assistance control, and
resume the parking assistance control in a case where a resumption condition that is predetermined is satisfied while the user is located within the first range during interruption of the parking assistance control; and
the interruption condition is set to be more likely to be satisfied than the resumption condition.

2. The parking assistance device according to claim 1, wherein:
the parking assistance device is configured to
determine that the interruption condition is satisfied in a case where a time during which the user is located outside the first range continues for an interruption threshold value time or longer during the execution of the parking assistance control, and
determine that the resumption condition is satisfied in a case where a time during which the user is located within the first range continues for a resumption threshold value time or longer during the interruption of the parking assistance control; and
the interruption condition is set to be more likely to be satisfied than the resumption condition by setting the interruption threshold value time to be shorter than the resumption threshold value time.

3. The parking assistance device according to claim 1, wherein:
the parking assistance device is configured to
determine that the interruption condition is satisfied in a case where, during the execution of the parking assistance control, a traveling distance of the vehicle from a time when the user is located outside the first range is equal to or longer than an interruption threshold value distance, and
determine that the resumption condition is satisfied in a case where, during the interruption of the parking assistance control, a traveling distance of the vehicle from a time when the user is located within the first range is equal to or longer than a resumption threshold value distance; and
the interruption condition is set to be more likely to be satisfied than the resumption condition by setting the interruption threshold value distance to be shorter than the resumption threshold value distance.

4. The parking assistance device according to claim 1, wherein the parking assistance device is configured to
set the interruption condition to be more likely to be satisfied than the resumption condition in a case where an inter-range distance between the first range and a second range set outside the first range and in which the vehicle is to decelerate is shorter than a threshold value distance, and
set the interruption condition to be less likely to be satisfied than the resumption condition in a case where the inter-range distance is equal to or longer than the threshold value distance.

5. The parking assistance device according to claim 4, wherein the parking assistance device is configured to
specify a position of the user relative to the vehicle, and
acquire a distance between the first range and the second range in a movement direction of the user relative to the vehicle from the position of the user as the inter-range distance.
